(19) United States
(12) Patent Application Publication
(10) Pub. No.: US 2015/0254359 A1
(43) Pub. Date: Sep. 10, 2015

(54) Systems and Methods for Searching an On-Line Database

(71) Applicants: Shawn Michael Webster, Atlanta, GA (US); Jonathan Michael Maloy, Marietta, GA (US)

(72) Inventors: Shawn Michael Webster, Atlanta, GA (US); Jonathan Michael Maloy, Marietta, GA (US)

(21) Appl. No.: 14/638,209

(22) Filed: Mar. 4, 2015

Related U.S. Application Data
(60) Provisional application No. 61/949,195, filed on Mar. 6, 2014.

(51) Int. Cl. G06F 17/30

(52) U.S. Cl. CPC G06F 17/30867; G06F 17/30398

(57) ABSTRACT

Methods and computing systems for providing a searchable on-line database are disclosed.

### CROSS-REFERENCE TO RELATED APPLICATIONS

This patent application claims the benefit of priority to U.S. provisional patent application Ser. No. 61/949,195 entitled “SYSTEMS AND METHODS FOR SEARCHING AN ON-LINE DATABASE” filed on Mar. 6, 2014, the subject matter of which is incorporated herein in its entirety.

### TECHNICAL FIELD

The disclosed embodiments are related to information systems. More particularly, the disclosed embodiments are related to systems and methods for searching an on-line database, such as a job posting site or a vehicle trading site.

### BACKGROUND

A lot of searchable websites exist including, but not limited to, job posting websites (e.g., www.monster.com), vehicle trading websites (www.autotrader.com), and others. Each website typically has its own unique search features, many of which require a user to input one or more search terms on one webpage, view search results on another webpage, and return back to a previous page in order to start a new search with different search terms.

A number of job-seeking websites are available for use by job seekers, headhunters and employers. For example, www.monster.com, www.dice.com, and www.krop.com all provide access to multiple jobs for a person seeking a job. However, known job-seeking websites including, but not limited to, www.monster.com, www.dice.com, and www.krop.com have one or more shortcomings. For example, on the www.monster.com website, below the “search fields” is an Advanced Search, which leads the job seeker to another page with a number of fields one can answer to then go back to a new page to see refined search results. If the jobseekers Advanced Search does not yield any results, the job seeker has to go back to square one to search for some new fields.

With the www.dice.com website, the job seeker utilizes what are called Search Agents in order to search for jobs. To create a Search Agent, the job seeker has to save an advanced search by one or more methods. However the job seeker does this, the website provides a link at the top of the list of jobs asking the job seeker to create the Search Agent. To then access the saved Search Agents, the maximum being five, the job seeker has to go back through his/her saved Dashboard, requiring the job seeker to click through a number of pages. Further, it is difficult to compare the variables the job seeker has within each Search Agent given that each variable is always on different web pages.

With the krop.com website homepage, the job seeker sees only two search fields and a list of jobs. If the job seeker clicks on a job, the job seeker is taken to a new screen where a list of jobs appears on the left and the primary job description is on the right, taking up most of the screen. However, there is no way to add/adjust any filters. The only choice for the job seeker is to keep scrolling and scrolling through the list of jobs.

Efforts continue to improve the search experience with searchable websites, such as job-seeking websites, so as to provide a better user experience without compromising website content.

### SUMMARY

The present invention addresses the shortcomings of known searchable websites, such as job-seeking websites, by providing systems and methods that enable a searcher to perform a number of searching tasks while viewing a single website. In one exemplary embodiment, the present invention is directed to a method of providing search information to a searcher via a web-based system, wherein the method comprises: displaying a list of one or more search filtering scenarios within a search filtering section of a searching view of a first webpage; displaying a first list of one or more search results within a search result section of the searching view of the first webpage based on a first set of search filters of a first scenario displayed in the list of one or more search filtering scenarios; and in response to selecting a second scenario displayed in the list of one or more search filtering scenarios, displaying a second list of one or more search results within the search result section based on a second set of search filters of the second scenario.

In another embodiment, the present invention is directed to a method of enabling a search via a web-based system, wherein the method comprises: allowing a searcher to perform each of the following tasks on a single webpage comprising a first webpage: viewing a complete list of one or more search results within a search result section of the first webpage; viewing a search filtering section of the first webpage, the search filtering section comprising a list of up to n distinct scenarios with each scenario comprising a set of search filters that filter one or more search results from a complete list of possible search targets; selecting a first scenario from the n distinct scenarios within the search filtering section of the first webpage; in response to said selecting the first scenario step, viewing a first list of one or more first search results within the search result section of the first webpage based on a first set of search filters of the first scenario; selecting a second scenario from the n distinct scenarios within the search filtering section of the first webpage; in response to said selecting the second scenario step, viewing a second list of one or more second search results within the search result section of the first webpage based on a second set of search filters of the second scenario, the second list of one or more second search results within the search result section of the first webpage being different from or the same as the first list of one or more first search results within the search result section of the first webpage; selecting a search result within the search result section of the first webpage; in response to said selecting a search result step, viewing one or more details about the selected search result within the search result section; selecting a given search result contact option displayed within the search result section on the first webpage; and in response to said selecting a given search result contact option step, initiating an information transfer to a third party for the selected search result, wherein the information transfer comprises providing, to the third party, an electronic copy of contact information of the searcher.

The present invention is further directed to a method of providing job related information to a job seeker. In one embodiment, the method of providing job related information to a job seeker is via a web-based system, and the method comprises: displaying a list of one or more job search filtering scenarios within a search filtering section of a searching view of a first webpage; displaying a first list of one or more job openings within a job board search result section of the searching view of the first webpage based on a first set of job search filters of a first scenario selected from the list of one or more job search filtering scenarios; and in response to selecting a second scenario within the search filtering section of the first webpage, displaying a second list of one or more job openings within the job board search result section of the first webpage based on a second set of job search filters of the second scenario.

In another embodiment, the method of the present invention comprises a method of enabling a job search via a web-based system, wherein the method comprises: allowing a job seeker to perform each of the following tasks on a single webpage comprising a first webpage: viewing a complete list of one or more job openings within a job board section of the first webpage; viewing a job search filtering section of the first webpage, the job search filtering section comprising up to n distinct scenarios with each scenario comprising a set of job search filters that filter one or more jobs from the complete list of one or more job openings based on the set of job search filters; selecting a first scenario from the n distinct scenarios within the job search filtering section of the first webpage; in response to said selecting the first scenario step, viewing a first list of one or more first job openings within the job board section of the first webpage based on a first set of job search filters of the first scenario; selecting a second scenario from the n distinct scenarios within the job search filtering section of the first webpage; in response to said selecting the second scenario step, viewing a second list of one or more second job openings within the job board section of the first webpage based on a second set of job search filters of the second scenario, the second list of one or more second job openings within the job board section of the first webpage being different from or the same as the first list of one or more first job openings within the job board section of the first webpage; selecting a job opening posting within the job board section of the first webpage; in response to said selecting a job opening posting step, viewing one or more job details about the selected job opening within the job board section, the one or more job details about the selected job opening comprising one or more of: a job title, a company name, a job type, a job term, a location of the job, a job description, and company information; applying for a given job opening displayed within the job board section on the first webpage; and in response to said applying step, initiating an information transfer to an employer or a recruiting company for the selected job opening, wherein the information transfer comprises providing, to the employer or the recruiting company, an electronic copy of at least one of: (i) a resume, (ii) contact information, or (iii) any combination thereof.

The present invention is further directed to computing systems that enable performance of the herein-disclosed methods. In one embodiment, the computer system comprises: a network interface; and a processor in communication with the network interface, the processor being configured to: display a list of one or more search filtering scenarios within a search filtering section of a searching view of a first webpage; display a first list of one or more search results within a search result section of the searching view of the first webpage based on a first set of search filters of a first scenario displayed in the list of one or more search filtering scenarios; and in response to selecting a second scenario displayed in the list of one or more search filtering scenarios, display a second list of one or more search results within the search result section based on a second set of search filters of the second scenario.

In another embodiment, the computer system comprises: a network interface; and a processor in communication with the network interface, the processor being configured to allow a searcher to: view a complete list of one or more search results within a search result section of the first webpage; view a search filtering section of the first webpage, the search filtering section comprising a list of up to n distinct scenarios with each scenario comprising a set of search filters that filter one or more search results from a complete list of possible search targets; select a first scenario from the n distinct scenarios within the search filtering section of the first webpage; in response to said selecting the first scenario step, view a first list of one or more first search results within the search result section of the first webpage based on a first set of search filters of the first scenario; select a second scenario from the n distinct scenarios within the search filtering section of the first webpage; in response to said selecting the second scenario step, view a second list of one or more second search results within the search result section of the first webpage based on a second set of search filters of the second scenario, the second list of one or more second search results within the search result section of the first webpage being different from or the same as the first list of one or more first search results within the search result section of the first webpage; select a search result within the search result section of the first webpage; in response to said selecting a search result step, view one or more details about the selected search result within the search result section; select a given search result contact option displayed within the search result section on the first webpage; and in response to said selecting a given search result contact option step, initiate an information transfer to a third party for the selected search result, wherein the information transfer comprises providing, to the third party, an electronic copy of contact information of the searcher

In yet another embodiment, the computer system comprises: a network interface; and a processor in communication with the network interface, the processor being configured to: display a list of one or more job search filtering scenarios within a search filtering section of a searching view of a first webpage; display a first list of one or more job openings within a job board search result section of the searching view of the first webpage based on a first set of job search filters of a first scenario selected from the list of one or more job search filtering scenarios; and in response to selecting a second scenario within the search filtering section of the first webpage, display a second list of one or more job openings within the job board search result section of the first webpage based on a second set of job search filters of the second scenario.

In yet another embodiment of the present invention, the computer system comprises: a network interface; and a processor in communication with the network interface, the processor being configured to: receive multiple inputs from a job seeker while displaying a single webpage comprising a first webpage; and allowing a job seeker to perform each of the following tasks on a single webpage comprising a first webpage: view a complete list of one or more job openings within a job board section of the first webpage; view a job search filtering section of the first webpage, the job search filtering section comprising up to n distinct scenarios with each scenario comprising a set of job search filters that filter one or more jobs from the complete list of one or more job openings based on the set of job search filters; select a first scenario from the n distinct scenarios within the job search filtering section of the first webpage; in response to said selecting the first scenario step, view a first list of one or more first job openings within the job board section of the first webpage based on a first set of job search filters of the first scenario; select a second scenario from the n distinct scenarios within the job search filtering section of the first webpage; in response to said selecting the second scenario step, view a second list of one or more second job openings within the job board section of the first webpage based on a second set of job search filters of the second scenario, the second list of one or more second job openings within the job board section of the first webpage being different from or the same as the first list of one or more first job openings within the job board section of the first webpage; select a job opening posting within the job board section of the first webpage; in response to said selecting a job opening posting step, view one or more job details about the selected job opening within the job board section, the one or more job details about the selected job opening comprising one or more of: a job title, a company name, a job type, a job term, a location of the job, a job description, and company information; applying for a given job opening displayed within the job board section on the first webpage; and in response to said applying step, initiate an information transfer to an employer or a recruiting company for the selected job opening, wherein the information transfer comprises providing, to the employer or the recruiting company, an electronic copy of at least one of: (i) a resume, (ii) contact information, or (iii) any combination thereof.

These and other features and advantages of the present invention will become apparent after a review of the following detailed description of the disclosed embodiments and the appended claims.

### DESCRIPTION OF THE DRAWINGS

FIG. 1 shows an exemplary webpage display that enables a job seeker to create one or more new scenarios (e.g., a set of filters) so as to focus a given job search on specific types of jobs meeting a job seeker's desired job features;

FIG. 2 shows the exemplary webpage display of FIG. 1 once a user has created a first scenario (e.g., a first set of filters) with the new exemplary webpage display showing specific jobs that meet the filter criteria of the first scenario;

FIG. 3 shows the exemplary webpage display of FIG. 2 once a user has inactivated the first scenario, removing the previously displayed jobs that meet the filter criteria of the first scenario;

FIG. 4 shows an exemplary webpage for editing a given scenario that appears once a user selects the “Edit Scenarios” button shown in the exemplary webpage display of FIGS. 1-3 scenarioscenarioscenario;

FIG. 5 shows the exemplary “edit scenario” webpage view after multiple scenarios have been created and/or edited by a user, the exemplary “edit scenario” webpage view showing all scenarios created by the user scenario;

FIG. 6 shows the exemplary job board webpage after a user selects the “Return To Job Board” option shown in the exemplary “edit scenario” webpage view of FIGS. 4-5 with Scenario 3 being highlighted and the search results associated with Scenario 3 displayed to a user;

FIG. 7 shows the exemplary job board webpage of FIG. 6 after a user has highlighted each of Scenarios 1 to 3 with the search results associated with each of Scenarios 1 to 3 being displayed to a user;

FIG. 8 shows the exemplary job board webpage of FIG. 7 after a user has inputted a search term (i.e., in this case, the word “media”) into the keyword search field shown above the list of search results and any search results (i) associated with each of Scenarios 1 to 3 and (ii) containing the keyword search term displayed to the user;

FIGS. 9A-9B show the exemplary job board webpage of FIG. 8 after a user has selected a specific search result (i.e., in this case, the “Digital Art Director” job) within the list of search results so as to display details of a given search result;

FIGS. 10A-10D show an example of a set of logical operations performed by a user and one or more computers to provide search information to a searcher (e.g., a job seeker); and

FIG. 11 depicts a schematic view of an exemplary computing system for performing the methods of the present invention.

### DETAILED DESCRIPTION

The present invention is directed to methods and systems for providing search tools to a searcher of a web-based, on-line database. Although the methods and systems are described below in the environment of a job-searcher website, it should be understood that the methods and systems of the present invention are applicable for any searchable website.

In one exemplary embodiment, the methods and systems of the present invention are applicable to job-searching websites. In these embodiments, the methods and systems of the present invention may provide a job board in the form of a “SaaS” (“Software as a Service”) type board, where employers and recruiting companies can post jobs for job seekers to apply to in hopes of finding employment. The methods and systems of the present invention deliver a more efficient, better service for both people hiring, as well as job seekers. In some embodiments, the methods and systems effectively provide two main components: (1) the job board for job seekers and (2) the dashboard/database for employers and recruiting companies. The present methods and systems provide a clean, simple dashboard that allows for more manageable job posting and candidate review.

One optional feature of the disclosed methods and systems is a subscription agreement, where an employer or recruiting company can buy a total number of posts per month, instead of a post at a time with a limited number of days that the individual job posting stays visible to the public. In the present methods and systems, each job post can be (i) removed from the job board after just 24 hours, (ii) filled in with all new information, and (iii) re-posted where the revised job posting appears back on the top of the job list.

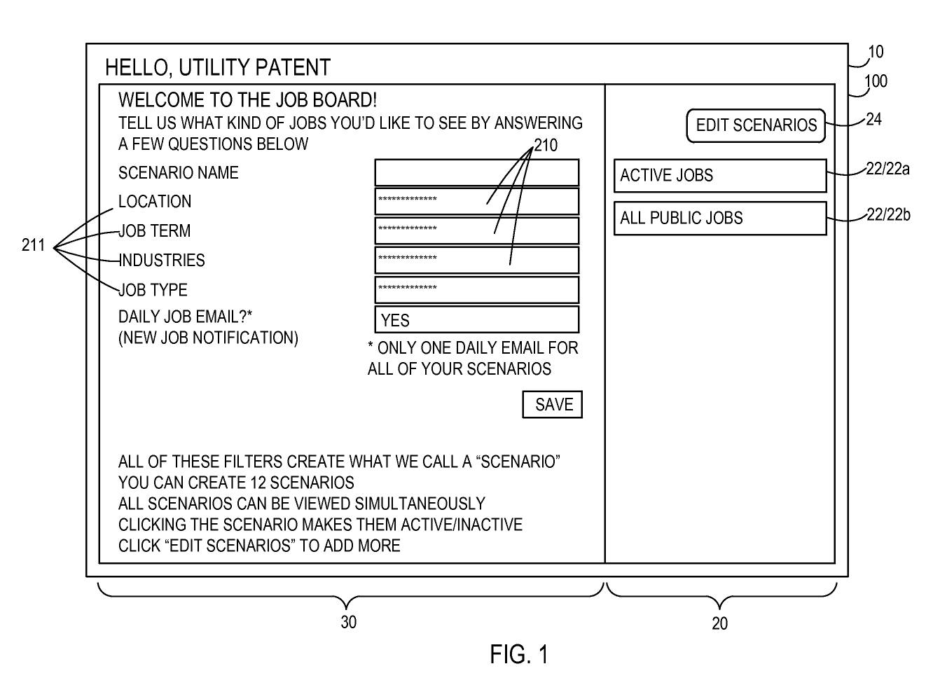

Another key feature of the present methods and systems is the actual job board, where the job seeker sees available positions. After a job seeker fills out a standard profile, providing basic information along with specific experience and dates (i.e., which is what is submitted to those posting jobs when applied to), the job seeker is brought to the job board as shown in FIG. 1.

As shown in FIG. 1, the job seeker is provided a webpage that enables the job seeker to perform two tasks: create new Scenarios and edit existing (i.e., previously prepared) Scenarios, both of which can be custom labeled for reference later as the job seeker navigates open job positions.

Each scenario comprises a list of search filters, namely, preferences that the job seeker uses to target jobs the job seeker specifically wants to see. Suitable search filters for each scenario include, but are not limited to, Job Term, Location, Compensation, Industry, Job Type, Daily Job Email Update, etc. Each scenario may provide the job seeker with multiple selection options such as the following:

Location: All of USA; Specific Location and Radius; Global (Non-USA); if “Specific Location and Radius” is selected, user inputs Zip Code or City, State or Address plus a desired radius of, for example, 5, 10, 15, 20, 30, 50, 75, or 100 miles;

Job Term: Full-time; Freelance/Contract; Part-Time; Internship;

Compensation: if Full-time, Salary Minimum; if Freelance, Daily Rate Minimum; if Part-time, Hourly Rate Minimum; and if Internship, Paid or Unpaid.

Industries: Choose from a list (e.g., healthcare, manufacturing, etc.), or choose Any Industry;

Job Type: Choose specific field/department within a chosen Industry; and

Daily Job Email: Yes or No (Note, the Daily Job Email does not affect the jobs the job seeker sees on the Job Board, as other Filters do, but chooses if the jobs chosen Scenarios will be emailed.)

The job seeker can add up to n different scenarios, each of which is viewable by the job seeker, along with search results associated with one or more selected scenarios, as discussed further below.

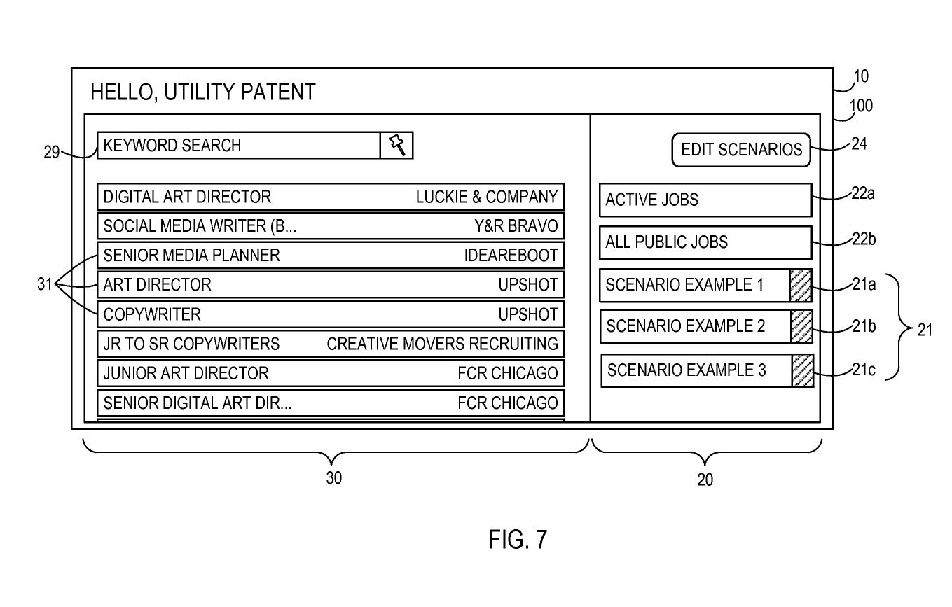

Within the Job Board section 30, any jobs that have been inputted by employers/recruiting companies that fall within the parameters of selected scenarios 21n will be visible to the job seeker. See, for example, FIG. 7. Clicking (i.e., deselecting or unhighlighting) on any other scenario 21 in the searching filtering section 20 will remove job posting 31 associated with the deselected scenario 21, and only display job postings 31 associated with any remaining highlighted scenarios 21. Accordingly, the job board section 30 will show a new list of jobs 31 as determined by the newly selected scenarios 21. Nowhere in any of these interactions has the job seeker been directed to a new page. Job seekers will have no reason to press the back or forward button on the browser. All primary interactions with the job board section 30 and the searching filtering section 20 are on one page, a singularly unique function exclusive to job board of the present invention.

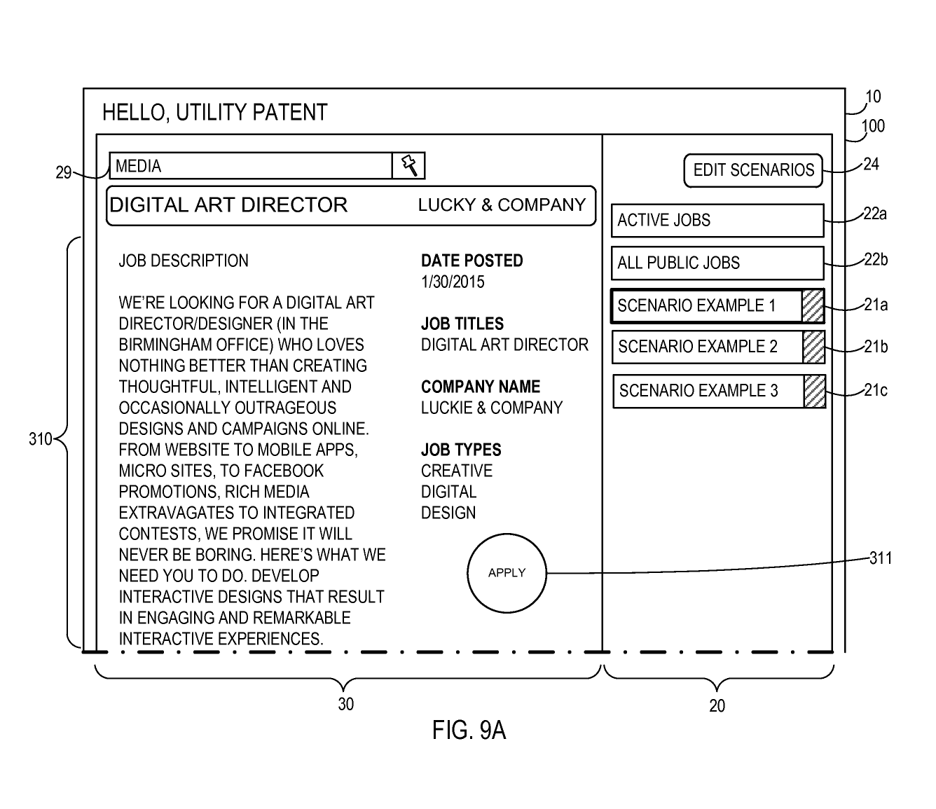

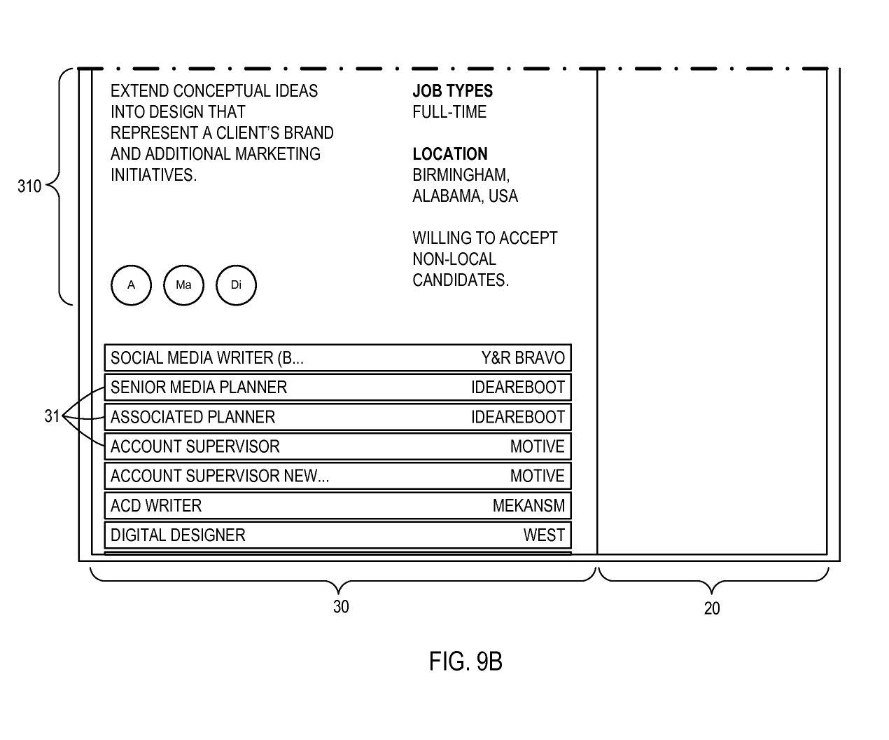

It should be noted for each job listing 31, by clicking on the job post 31, details of the job post 310 are also provided to the job seeker without leaving the webpage 10. In some embodiments, a list of industries is also provided. Further, the task of applying for and receiving feedback on a selected/applied for job 31 may also takes place on the same webpage 10. See, for example, FIGS. 9A-9B.

In the methods and systems of the present invention, the steps of filling in log-in information, updating profile information, removing blocks and updating account information require the user/job seeker to move to a new page. Once the job seeker provides log-in information, profile information, blocks and account information, for example, after one visit to the website, the job seeker may never have to go to any other webpage except for the primary job board page for all further interactions.

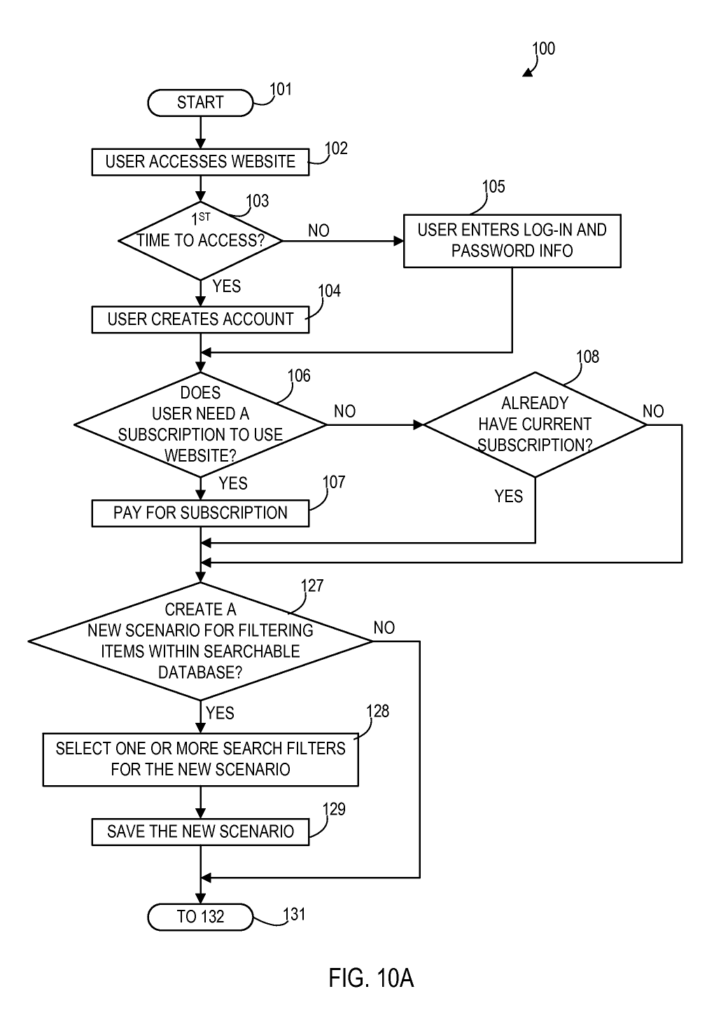

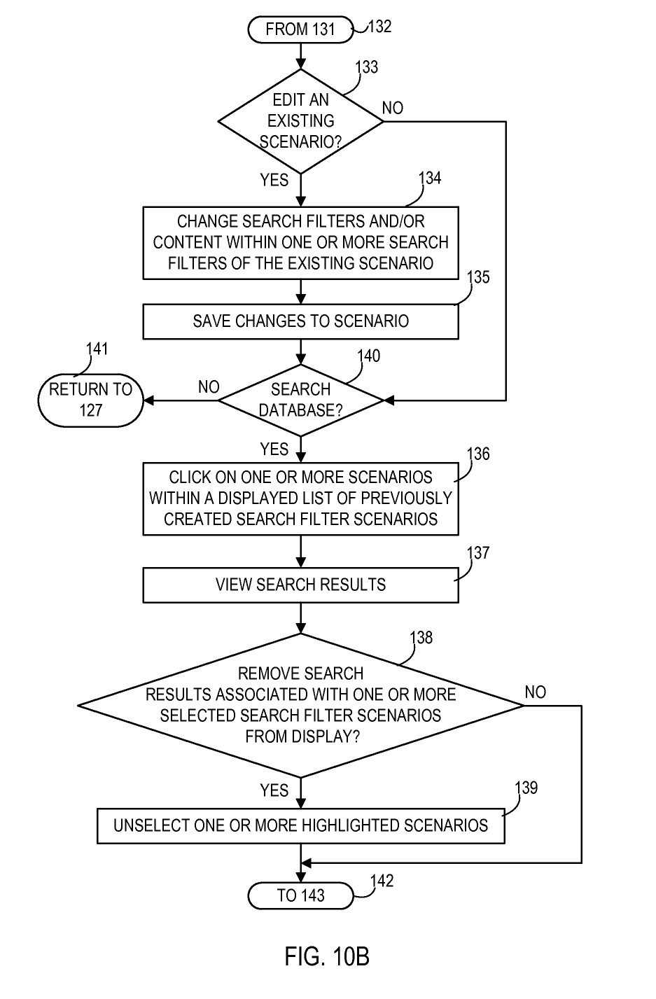

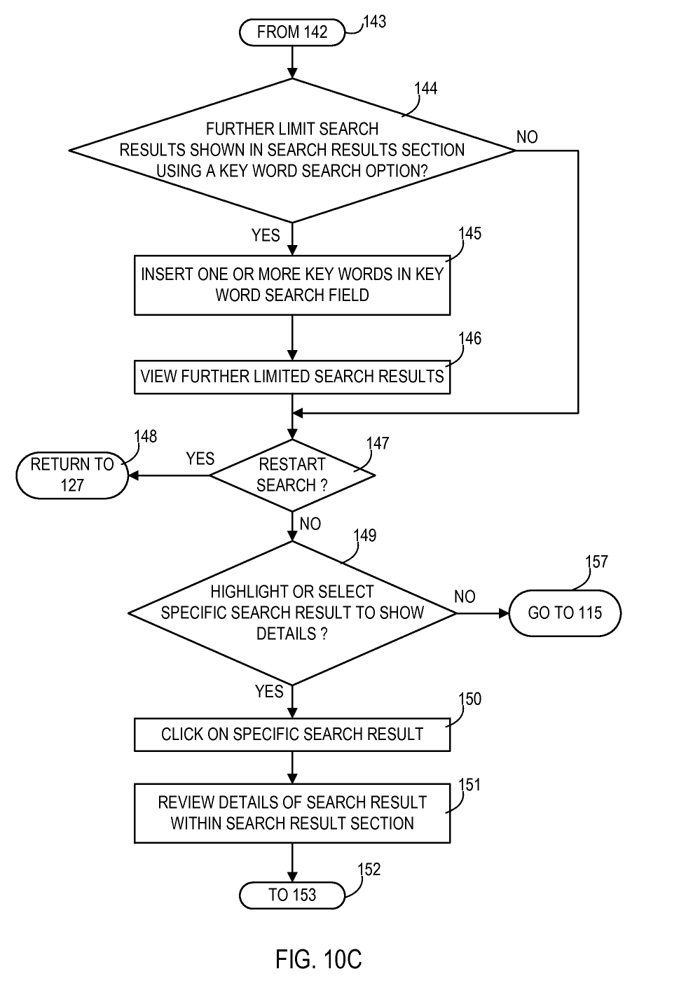

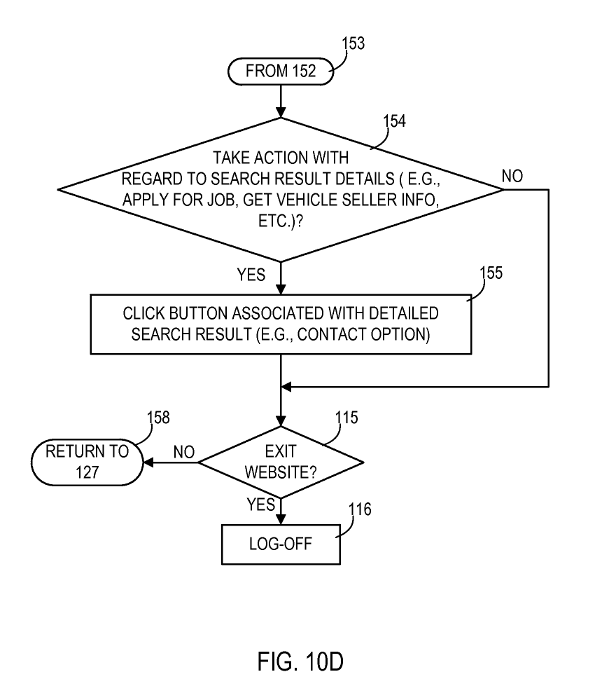

FIGS. 10A-10D provide a flow diagram describing some of the logical steps taken using the methods and systems of the present invention. As shown in FIG. 10A, exemplary method 100 starts at start block 101 and proceeds to step 102, wherein a user accesses a website (e.g., a job-posting website, a vehicle trading website, a medical provider website, or any other website that comprises a searchable database of items). From step 102, exemplary method 100 proceeds to decision block 103, where a determination is made whether this is the first time that the user has accessed the website. If a determination is made at decision block 103 that this is the first time that the user has accessed the website, exemplary method 100 proceeds to step 104, where a user creates a user account (e.g., accessible via a user name, password, etc.).

From step 104, exemplary method 100 proceeds to decision block 106, where a determination is made whether the user needs a subscription to access the website (e.g., the user is an employer or recruiting company posting jobs on the website or the user is a car salesperson posted cars on the website). If a determination is made at decision block 106 that the user needs a subscription to access the website, exemplary method 100 proceeds to step 107, where a user pays for a subscription. From step 107, exemplary method 100 proceeds to decision block 127 discussed below.

Returning to decision block 103, if a determination is made at decision block 103 that this is not the first time that the user has accessed the website, exemplary method 100 proceeds to step 105, where a user enters his/her log-in information (e.g., user name and password) to access the website. From step 105, exemplary method 100 proceeds to decision block 106, and continues as discussed herein.

Returning to decision block 106, if a determination is made at decision block 106 that the user does not need a subscription to access the website, exemplary method 100 proceeds to decision block 108, where a determination is made whether the user already has a current subscription to access the website (e.g., the user is an employer or recruiting company posting jobs on the website or the user is a car salesperson posted cars on the website). If a determination is made at decision block 108 that the user already has a current subscription to access the website, exemplary method 100 proceeds to decision block 127, where a determination is made whether the user wants to create a new scenario for filtering items within a searchable database (e.g., a list of jobs available, a list of vehicles for sale, etc.). If a determination is made at decision block 127 that the user wants to create a new scenario for filtering items within a searchable database, exemplary method 100 proceeds to step 128, where the user selects one or more search filters and content for the one or more search filters in order to form a new scenario. From step 128, exemplary method 100 proceeds to step 129, where the user saves the new scenario 21. From step 129, exemplary method 100 proceeds to block 131 and proceeds as discussed below.

Returning to decision block 108, if a determination is made at decision block 108 that the user does not have a current subscription to enter the website (e.g., the user is a searcher, not someone providing one or more searchable items in the searchable database), exemplary method 100 proceeds directly to decision block 127 and proceeds as discussed herein.

Returning to decision block 127, if a determination is made at decision block 127 that the user does not want to create a new scenario for filtering items within a searchable database, exemplary method 100 proceeds directly to block 131 and proceeds as discussed herein.

From block 131 shown in FIG. 10A, exemplary method 100 proceeds to block 132 shown in FIG. 10B, and proceeds to decision block 133, where a determination is made whether the user wants to edit an existing (i.e., previously created) scenario 21 for filtering items within a searchable database (e.g., a list of jobs available, a list of vehicles for sale, etc.). If a determination is made at decision block 133 that the user wants to edit an existing (i.e., previously created) scenario 21 for filtering items within a searchable database, exemplary method 100 proceeds to step 134, where the user changes one or more search filters and/or content within the one or more search filters of the existing scenario. From step 134, exemplary method 100 proceeds to step 135, where the user saves the newly edited existing scenario 21.

From step 135, exemplary method 100 proceeds to decision block 140, where a determination is made whether the user wants to search a database using one or more of the previously created scenarios 21 for filtering items within a searchable database (e.g., a list of jobs available, a list of vehicles for sale, etc.). If a determination is made at decision block 140 that the user wants to search a database using one or more of the previously created scenarios 21, exemplary method 100 proceeds to step 136, where the user clicks on (i.e., selects) one or more previously created scenarios 21 within a list of previously created scenarios 21 displayed within a search filtering section 20 of the webpage 10. From step 136, exemplary method 100 proceeds to step 137, where the user views the search results within search result section 30 if the webpage 10.

From step 137, exemplary method 100 proceeds to decision block 138, where a determination is made whether the user wants to remove one or more search results associated with the one or more currently selected scenarios 21. If a determination is made at decision block 138 that the user wants to remove one or more search results associated with the one or more currently selected scenarios 21, exemplary method 100 proceeds to step 139, where the user clicks on (i.e., unselects or unhighlights) one or more previously selected scenarios 21. From step 139, exemplary method 100 proceeds to block 142.

Returning to decision block 133, if a determination is made at decision block 133 that the user does not want to edit an existing (i.e., previously created) scenario 21, exemplary method 100 proceeds directly to decision block 140 and proceeds as discussed herein.

Returning to decision block 140, if a determination is made at decision block 140 that the user does not want to search a database using one or more of the previously created scenarios 21, exemplary method 100 proceeds to step 141, where exemplary method 100 returns to decision block 127 and proceeds as discussed herein.

From block 142 shown in FIG. 10B, exemplary method 100 proceeds to block 143 shown in FIG. 10C, and then proceeds to decision block 144, where a determination is made whether the user wants to further limit the displayed search results shown in the search result section 30 by using a key word search feature 29. If a determination is made at decision block 144 that the user wants to further limit the displayed search results shown in the search result section 30 by using a key word search feature 29, exemplary method 100 proceeds to step 145, where the user inputs one or more keywords 27 into the key word search field 29. From step 145, exemplary method 100 proceeds to step 146, where the user views the further limited search results within the search result section 30.

From step 146, exemplary method 100 proceeds to decision block 147, where a determination is made whether the user wants to restart a new search. If a determination is made at decision block 147 that the user wants to restart a new search, exemplary method 100 proceeds to step 148, where exemplary method 100 returns to decision block 127 and proceeds as discussed herein. If a determination is made at decision block 147 that the user does not want to restart a new search, exemplary method 100 proceeds to decision block 149, where a determination is made whether the user wants to highlight (i.e., select) a specific search result so as to show details of the specific search result within the search result section 30. If a determination is made at decision block 149 that the user wants to highlight (i.e., select) a specific search result so as to show details of the specific search result within the search result section 30, exemplary method 100 proceeds to step 150, where the user clicks on a specific search result 31. From step 150, exemplary method 100 proceeds to step 151, where the user views detailed information of the specific search result within the search result section 30. From step 151, exemplary method 100 proceeds to block 152.

Returning to decision block 144, if a determination is made at decision block 140 that the user does not want to further limit the displayed search results shown in the search result section 30 by using a key word search feature 29, exemplary method 100 proceeds directly to decision block 147 and proceeds as discussed herein.

Returning to decision block 149, if a determination is made at decision block 140 that the user does not want to highlight (i.e., select) a specific search result so as to show details of the specific search result within the search result section 30, exemplary method 100 proceeds to block 157 and proceeds as discussed herein.

From block 152 shown in FIG. 10C, exemplary method 100 proceeds to block 153 shown in FIG. 10D, and then proceeds to decision block 154, where a determination is made whether the user wants to take any action with regard to detailed information provided for the specific search result highlighted in step 150 (e.g., initiate a contact option 311). If a determination is made at decision block 154 that the user wants to take any action with regard to detailed information provided for the specific search result highlighted in step 150 (e.g., initiate a contact option 311), exemplary method 100 proceeds to step 155, where the user clicks one or more buttons associated with the detailed information provided for the specific search result (e.g., clicks on a contact option 311).

From step 155, exemplary method 100 proceeds to decision block 115, where a determination is made whether the user wants to exit the website. If a determination is made at decision block 115 that the user wants to exit the website, exemplary method 100 proceeds to step 116, where the user logs off of the website. If a determination is made at decision block 115 that the user does not want to exit the website, exemplary method 100 proceeds to step 158, where exemplary method 100 returns to decision block 127 and proceeds as discussed herein.

Returning to decision block 154, if a determination is made at decision block 140 that the user does not want to take any action with regard to detailed information provided for the specific search result highlighted in step 150 (e.g., initiate a contact option 311), exemplary method 100 proceeds directly to decision block 115 and proceeds as discussed herein.

Returning to block 157 shown in FIG. 10C, from block 157, exemplary method 100 proceeds directly to decision block 115 shown in FIG. 10D and proceeds as discussed herein.

It should be noted that steps/blocks 127-155 of exemplary method 100 occur on a single (i.e., the same) webpage of a given website. The user, when performing all of the steps within steps/blocks 127-155 of exemplary method 100 does not have to return to a previous webpage, push the return button, or navigate the website in any way other than to choose options on the single website. This provides a significant advantage over known searchable websites that require a user to exit a search results page in order to (i) review search results, (ii) initiate a new search, (iii) modify search terms, etc.

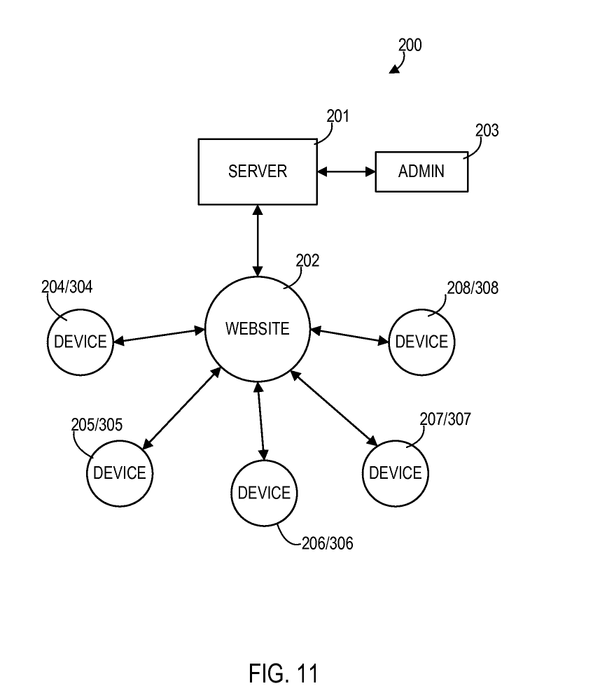

FIG. 11 depicts a schematic view of an exemplary computing system 200 for performing the methods of the present invention. As shown in FIG. 11, one or more users 204-208 may access a website 202 via one or more individual devices 304-308. Each individual device 304-308 may independently comprise a desk-top computer, a lap-top computer, a smart phone, a tablet, or any other device capable of accessing a website such as website 202. Exemplary computing system 200 further comprises a server 201 and an administrator 203 that maintains the server and website 202.

Further additional embodiments of the present invention are described below.

### Additional Embodiments:

Method Embodiments

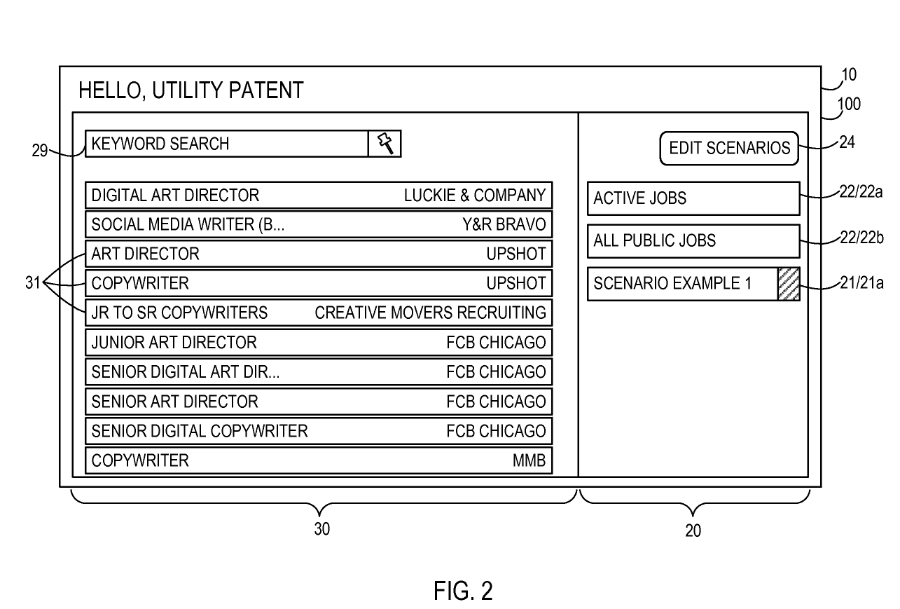

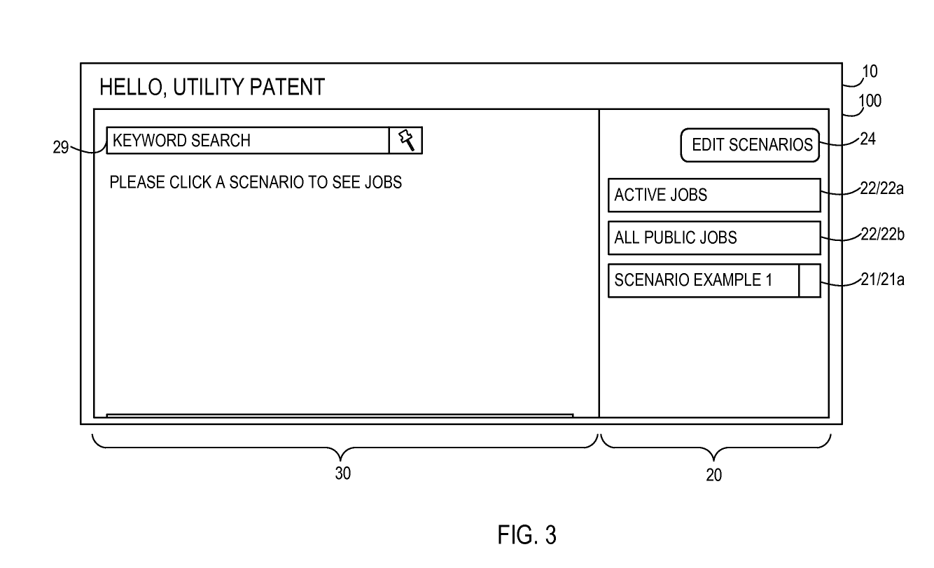

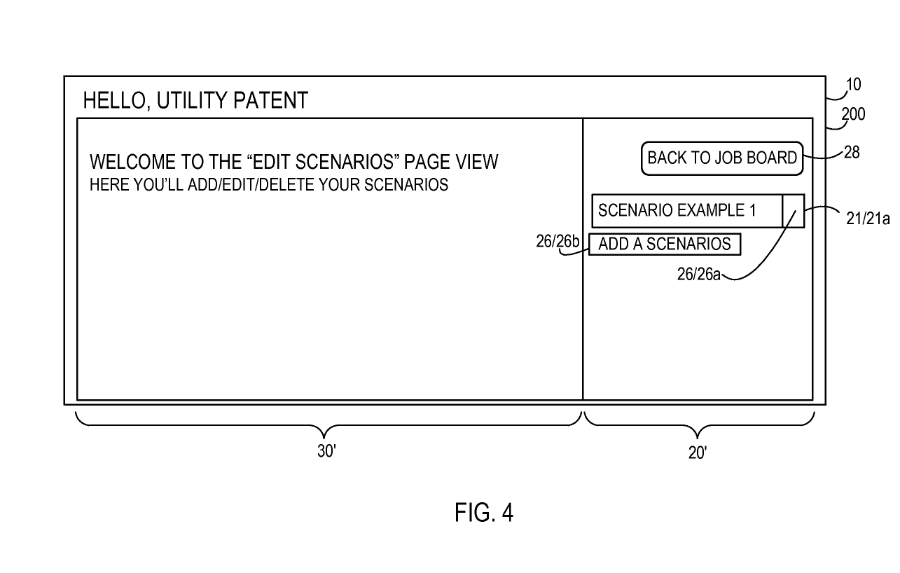

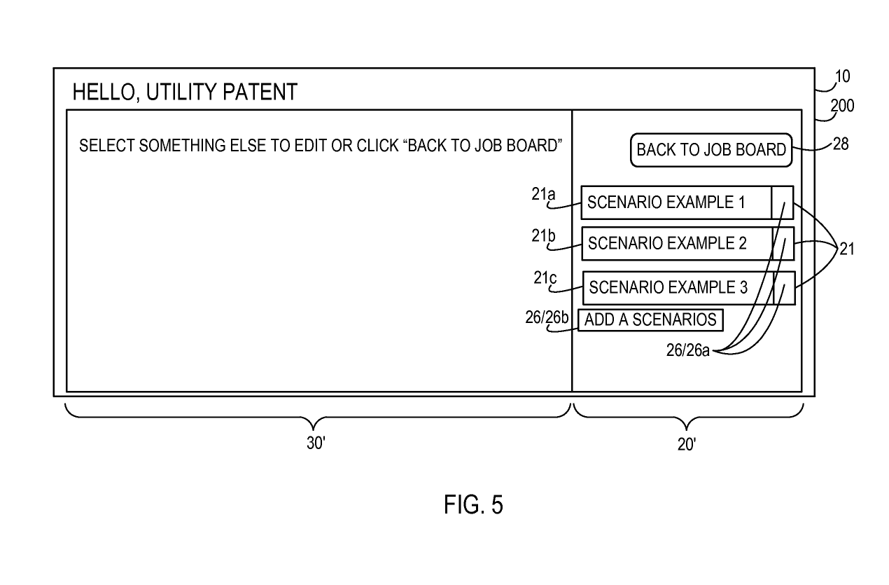

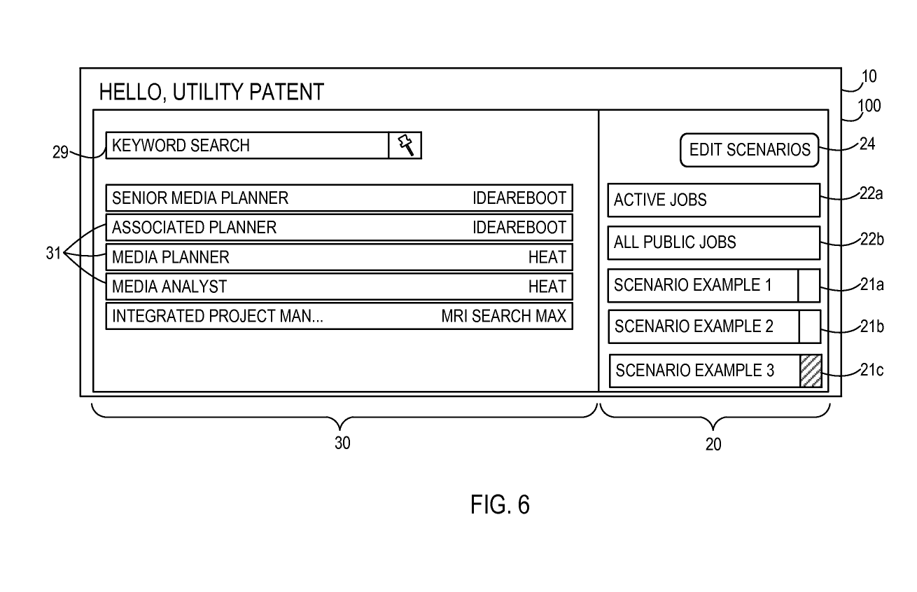

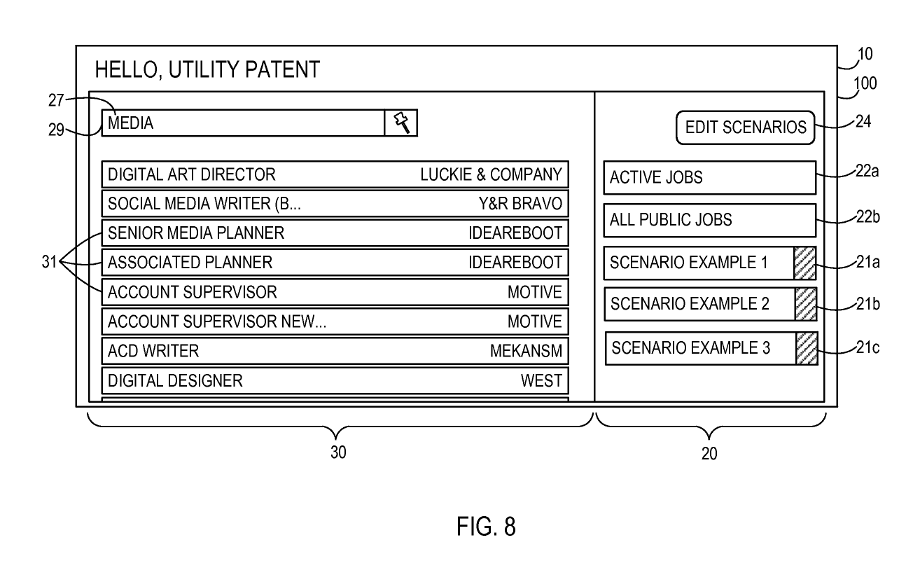

1. A method of providing search information to a searcher via a web-based system 200, said method comprising: displaying a list of one or more search filtering scenarios 21 within a search filtering section 20 of a searching view 100 of a first webpage 10; displaying a first list of one or more search results 31a within a search result section 30 of the searching view 100 of the first webpage 10 based on a first set of search filters 211 of a first scenario 21a displayed in the list of one or more search filtering scenarios 21; and in response to selecting a second scenario 21b displayed in the list of one or more search filtering scenarios 21, displaying a second list of one or more search results 31b within the search result section 30 based on a second set of search filters 211 of the second scenario 31b.
2. The method of embodiment 1, wherein said displaying a list of one or more search filtering scenarios 21 within a search filtering section 20 of the searching view 100 of the first webpage 10 comprises displaying up to n scenarios 21 within the search filtering section 20. It should be noted that n may be any whole number. Typically, n ranges from about 2 to about 100 (or any number between 2 and 100), more typically, from about 3 to about 10.
3. The method of embodiment 1 or 2, further comprising: displaying up to about twelve distinct scenarios 21 within the search filtering section 20.
4. The method of any one of embodiments 1 to 3, further comprising: displaying one or more additional search filtering options 22 within the search filtering section 20, the one or more additional search filtering options 22 comprising at least one of: (i) an all-inclusive search target option 22a, and (ii) a general description search option 22b. As shown in FIG. 1, an example of an all-inclusive search target option 22a is the Active Jobs option 22a, while an example of a general description search option 22b is the All Public Jobs option 22b.
5. The method of any one of embodiments 1 to 4, further comprising: in response to deselecting the first scenario 21a, removing the first list of one or more search results 31a from the search result section 30.
6. The method of any one of embodiments 1 to 5, further comprising: in response to creating a new user account, displaying one or more empty fields 210 for search filters 211 for forming a new scenario within the search result section 30. See, for example, the searching view 100 of the first webpage 10 shown in FIG. 1.
7. The method of embodiment 6, wherein the one or more search filters 211 comprise up to x search filters 211 within the search result section 30 of the first webpage 10. It should be noted that x may be any whole number. Typically, x ranges from about 2 to about 100 (or any number between 2 and 100), more typically, from about 3 to about 10.
8. The method of embodiment 6 or 7, further comprising: in response to the searcher inputting and saving information within fields 210 of the search filters 211, creating the first scenario 21a and displaying the first scenario 21a within the search filtering section 20 of the first webpage 10. See, for example, the view of first webpage 10 shown in FIG. 2.
9. The method of any one of embodiments 1 to 8, further comprising: in response to selecting an edit scenarios button 24 of the searching view 100 of the first webpage 10, displaying an edit scenario view 200 of the first webpage 10, the edit scenario view 200 providing the searcher with one or more scenario editing options 26 selected from: (1) editing an existing scenario 26a, (2) creating a new scenario 26b, and (3) deleting an existing scenario (not shown), all of which are provided in the search editing section 20′ of edit scenario view 200.
10. The method of embodiment 9, further comprising: in response to selecting the editing an existing scenario option 26a, displaying previously completed fields 210 of the search filters 211 for the existing scenario 21 (e.g., first scenario 21a) within the search result section 30 of the first webpage 10, and in response to making one or more changes in the previously completed fields 210 and saving of the one or more changes in the previously completed fields 210, displaying the newly edited existing scenario 21 within the search filtering section 20 of the first webpage 10.
11. The method of embodiment 9 or 10, further comprising: in response to selecting the creating a new scenario option 26b, displaying empty fields 210 of the search filters 211 for a new scenario 21 within the search result section 30 of the first webpage 10, and in response to making one or more changes in the empty fields 210 and saving of the one or more changes in the empty fields 210, displaying the new scenario 21 within the search filtering section 20 of the first webpage 10.
12. The method of any one of embodiments 9 to 11, wherein the edit scenario view 200 of the first webpage 10 provides a return button 28, and in response to the searcher selecting the return button 28, returning to the searching view 100 of the first webpage 10 showing the list of one or more filtering scenarios 21 within the search filtering section 20 of a first webpage 10. See, for example, return button 28 shown in FIG. 4 and designated “Back to Job Board” in this specific exemplary embodiment.
13. The method of any one of embodiments 1 to 12, further comprising: in response to selecting (i.e., highlighting) two or more scenarios 21 (e.g., first scenario 21a and third scenario 21c) from the list of one or more filtering scenarios 21 within the search filtering section 20, displaying search results 31 within the search result section 30 of the first webpage 10 based on distinct sets of search filters 211 of the two or more scenarios. As shown, for example, in FIG. 8, all search results 31 associated with each of first scenario 21a, second scenario 21b and third scenario 21c are shown in the search result section 30 of the first webpage 10.
14. The method of any one of embodiments 1 to 13, further comprising: in response to inputting a keyword search term within a keyword search field 29 within the search result section 30 of the first webpage 10, displaying search result 31 within the search result section 30 that (1) correspond to search filters 221 of one of more selected scenarios 21 from list of one or more filtering scenarios 21, and (2) contain the keyword search term inputted into the keyword search field 29. See, for example, the keyword search term “media” within the keyword search field 29 shown in FIG. 8.
15. The method of any one of embodiments 1 to 14, further comprising: in response to selecting (i.e., highlighting) a specific search result 31 within the search result section 30 of the first webpage 10, displaying one or more details 310 about the specific search result 31 within the search result section 30. See, for example, details shown in FIGS. 9A-9B.
16. The method of embodiment 15, wherein the one or more details 310 about the specific search result 31 comprise one or more of: a job title, a company name, a job type, a job term, a location of the job, a job description, company information, vehicle information, a vehicle owner's contact information, or any combination thereof
17. The method of embodiment 15 or 16, further comprising: in response to deselecting (i.e., unhighlighting) the specific search result 31 within the search result section 30 of the first webpage 10, removing the one or more details 310 of the specific search result 31 from the search result section 30.
18. The method of any one of embodiments 15 to 17, further comprising: displaying a contact option 311 for the specific search result 31 within the search result section 30 of the first webpage 10. For example, see exemplary contact option 311 shown in the form of an “Apply” button 311 in FIG. 9A.
19. The method of embodiment 18, further comprising: in response to selecting the contact option 311, initiating an information transfer between the searcher and a third party associated with the specific search result 31.
20. The method of embodiment 19, wherein the information transfer comprises providing, to the third party, contact information of the searcher.
21. The method of any one of embodiments 18 to 20, further comprising: in response to the searcher selecting the contact option 311, initiating an electronic notice to the searcher that the third party received notice of the searcher's interest in the specific search result 31.
22. A method of enabling a search via a web-based system 200, said method comprising: allowing a searcher to perform each of the following tasks on a single webpage comprising a first webpage 10: viewing a complete list of one or more search results 31 within a search result section 30 of the first webpage 10; viewing a search filtering section 20 of the first webpage 10, the search filtering section 20 comprising a list of up to n distinct scenarios 21 with each scenario 21n comprising a set of search filters 211 that filter one or more search results 31 from a complete list of possible search targets; selecting a first scenario 21a from the n distinct scenarios 21 within the search filtering section 20 of the first webpage 10; in response to said selecting the first scenario step, viewing a first list of one or more first search results 31a within the search result section 30 of the first webpage 10 based on a first set of search filters 211 of the first scenario 21a; selecting a second scenario 21b from the n distinct scenarios 21 within the search filtering section 20 of the first webpage 10; in response to said selecting the second scenario step, viewing a second list of one or more second search results 31b within the search result section 30 of the first webpage 10 based on a second set of search filters 211 of the second scenario 21b, the second list of one or more second search results 31b within the search result section 30 of the first webpage 10 being different from or the same as the first list of one or more first search results 31a within the search result section 30 of the first webpage 10; selecting a search result 31 within the search result section 30 of the first webpage 10; in response to said selecting a search result step, viewing one or more details 310 about the selected search result 31 within the search result section 30; selecting a given search result contact option 311 displayed within the search result section 30 on the first webpage 10; and in response to said selecting a given search result contact option step, initiating an information transfer to a third party for the selected search result, wherein the information transfer comprises providing, to the third party, an electronic copy of contact information of the searcher.
23. The method of embodiment 22, wherein the one or more details 310 about the selected search result 31 comprises one or more of: a job title, a company name, a job type, a job term, a location of the job, a job description, company information, vehicle information, vehicle owner information, etc.
24. The method of embodiment 22 or 23, further comprising: allowing the searcher to create and save up to n distinct scenarios 21, each distinct scenario 21n comprising one or more search filters 211 completed by the searcher.
25. The method of embodiment 24, wherein each distinct scenario 21n comprising from about 4 to about 12 search filters 211 utilized by the searcher.
26. The method of embodiment 24 or 25, wherein the one or more search filters 211 comprise Location, Compensation, Industry, Job Type, Job Term, Daily Job Email Update, vehicle type, maximum vehicle cost, vehicle year, (or any other search term), or any combination thereof.
27. The method of any one of embodiments 22 to 26, further comprising: allowing the searcher to proceed to an edit scenarios view 200 of the first webpage 10, the edit scenario view 200 providing the searcher with one or more scenario editing options 26 selected from: (1) editing an existing scenario 26a, (2) creating a new scenario 26b, and (3) deleting an existing scenario (not shown).
28. The method of any one of embodiments 22 to 27, further comprising: allowing the searcher to input a keyword search term into a keyword search field 29 within the search result section 30 of the first webpage 10 so as to display search results 31 within the search result section 30 that (1) correspond to search filters 211 of one of more selected scenarios 21 from the list of up to n distinct scenarios 21, and (2) contain the keyword search term inputted into the keyword search field 29. See, for example, the keyword search term “media” within the keyword search field 29 shown in FIG. 8.
29. A method of providing job related information to a job seeker via a web-based system, said method comprising: displaying a list of one or more job search filtering scenarios 21 within a search filtering section 20 of a searching view 100 of a first webpage 10; displaying a first list of one or more job openings 31a within a job board search result section 30 of the searching view 100 of the first webpage based on a first set of job search filters 221 of a first scenario 21a selected from the list of one or more job search filtering scenarios 21; and in response to selecting a second scenario 21b within the search filtering section 20 of the first webpage 10, displaying a second list of one or more job openings 31b within the job board search result section 30 of the first webpage 10 based on a second set of job search filters 221 of the second scenario 21b.
30. The method of embodiment 29, wherein said displaying a list of one or more job search filtering scenarios 21 within a search filtering section 20 of the searching view 100 of the first webpage 10 comprises displaying up to n job search filtering scenarios 21 within the search filtering section 20. It should be noted that n may be any whole number. Typically, n ranges from about 2 to about 100 (or any number between 2 and 100), more typically, from about 3 to about 10.
31. The method of embodiment 29 or 30, further comprising: displaying up to about twelve distinct job search filtering scenarios 21 within the search filtering section 20.
32. The method of any one of embodiments 29 to 31, further comprising: displaying one or more additional job search filtering options 22 within the search filtering section 20, the one or more additional job search filtering options 22 comprising at least one of: (i) an all-inclusive job search target option 22a, and (ii) a general description job search option 22b. As shown in FIG. 1, an example of an all-inclusive job search target option 22a is the “Active Jobs” option 22a, while an example of a general description job search option 22b is the “All Public Jobs” option 22b.
33. The method of any one of embodiments 29 to 32, further comprising: in response to deselecting the first job search filtering scenario 21a, removing the first list of one or more job search results 31a from the search result section 30.
34. The method of any one of embodiments 29 to 33, further comprising: in response to creating a new user account, displaying one or more empty fields 210 for job search filters 211 for forming a new scenario within the search result section 30. See, for example, the searching view 100 of the first webpage 10 shown in FIG. 1.
35. The method of embodiment 34, wherein the one or more job search filters 211 comprise up to x job search filters 211 within the search result section 30 of the first webpage 10. It should be noted that x may be any whole number. Typically, x ranges from about 2 to about 100 (or any number between 2 and 100), more typically, from about 3 to about 10.
36. The method of embodiment 34 or 35, further comprising: in response to the searcher inputting and saving information within fields 210 of the job search filters 211, creating the first job search filtering scenario 21a and displaying the first job search filtering scenario 21a within the search filtering section 20 of the first webpage 10. See, for example, the view of first webpage 10 shown in FIG. 2.
37. The method of any one of embodiments 29 to 36, further comprising: in response to selecting an edit scenarios button 24 of the searching view 100 of the first webpage 10, displaying an edit scenario view 200 of the first webpage 10, the edit scenario view 200 providing the searcher with one or more scenario editing options 26 selected from: (1) editing an existing job search filtering scenario 26a, (2) creating a new job search filtering scenario 26b, and (3) deleting an existing job search filtering scenario (not shown).
38. The method of embodiment 37, further comprising: in response to selecting the editing an existing scenario option 26a, displaying previously completed fields 210 of the job search filters 211 for the existing job search filtering scenario 21 (e.g., first job search filtering scenario 21a) within the search result section 30 of the first webpage 10, and in response to making one or more changes in the previously completed fields 210 and saving of the one or more changes in the previously completed fields 210, displaying the newly edited existing job search filtering scenario 21 within the search filtering section 20 of the first webpage 10.
39. The method of embodiment 37 or 38, further comprising: in response to selecting the creating a new job search filtering scenario option 26b, displaying empty fields 210 of the job search filters 211 for a new job search filtering scenario 21 within the search result section 30 of the first webpage 10, and in response to making one or more changes in the empty fields 210 and saving of the one or more changes in the empty fields 210, displaying the new job search filtering scenario 21 within the search filtering section 20 of the first webpage 10.
40. The method of any one of embodiments 37 to 39, wherein the edit scenario view 200 of the first webpage 10 provides a return button 28, and in response to the searcher selecting the return button 28, returning to the searching view 100 of the first webpage 10 showing the list of one or more job search filtering scenarios 21 within the search filtering section 20 of a first webpage 10. See, for example, return button 28 shown in FIG. 4 and designated “Back to Job Board” in this specific exemplary embodiment.
41. The method of any one of embodiments 29 to 40, further comprising: in response to selecting (i.e., highlighting) two or more job search filtering scenarios 21 (e.g., first job search filtering scenario 21a and third job search filtering scenario 21c) from the list of one or more job search filtering scenarios 21 within the search filtering section 20, displaying search results 31 within the search result section 30 of the first webpage 10 based on distinct sets of job search filters 211 of the two or more job search filtering scenarios. As shown, for example, in FIG. 8, all search results 31 associated with each of first job search filtering scenario 21a, second job search filtering scenario 21b and third job search filtering scenario 21c are shown in the search result section 30 of the first webpage 10.
42. The method of any one of embodiments 29 to 41, further comprising: in response to inputting a keyword search term within a keyword search field 29 within the search result section 30 of the first webpage 10, displaying search result 31 within the search result section 30 that (1) correspond to job search filters 221 of one of more selected job search filtering scenarios 21 from list of one or more job search filtering 21, and (2) contain the keyword search term inputted into the keyword search field 29. See, for example, the keyword search term “media” within the keyword search field 29 shown in FIG. 8.
43. The method of any one of embodiments 29 to 42, further comprising: in response to selecting (i.e., highlighting) a specific job search result 31 within the search result section 30 of the first webpage 10, displaying one or more job details 310 about the specific job search result 31 within the search result section 30. See, for example, job details shown in FIGS. 9A-9B.
44. The method of embodiment 43, wherein the one or more job details 310 about the specific search result 31 comprise one or more of: a job title, a company name, a job type, a job term, a location of the job, a job description, company information, or any combination thereof.
45. The method of embodiment 43 or 44, further comprising: in response to deselecting (i.e., unhighlighting) the specific job search result 31 within the search result section 30 of the first webpage 10, removing the one or more job details 310 of the specific job search result 31 from the search result section 30.
46. The method of any one of embodiments 43 to 45, further comprising: displaying a contact option 311 for the specific job search result 31 within the search result section 30 of the first webpage 10. For example, see exemplary contact option 311 shown in the form of an “Apply” button 311 in FIG. 9A.
47. The method of embodiment 46, further comprising: in response to selecting the contact option 311, initiating an information transfer between the searcher and a third party associated with the specific job search result 31.
48. The method of embodiment 47, wherein the information transfer comprises providing, to the third party, one or more of: contact information of the searcher, a resume, or both.
49. The method of any one of embodiments 46 to 48, further comprising: in response to the searcher selecting the contact option 311, initiating an electronic notice to the searcher that the third party received notice of the searcher's interest in the specific job search result 31.
50. A method of enabling a job search via a web-based system 200, said method comprising: allowing a job seeker to perform each of the following tasks on a single webpage comprising a first webpage 10: viewing a complete list of one or more job openings 31 within a job board section 30 of the first webpage 10; viewing a job search filtering section 20 of the first webpage 10, the job search filtering section 20 comprising up to n distinct scenarios 21 with each scenario 21n comprising a set of job search filters 211 that filter one or more jobs 31 from the complete list of one or more job openings 31 based on the set of job search filters 211; selecting a first scenario 21a from the n distinct scenarios 21 within the job search filtering section 20 of the first webpage 10; in response to said selecting the first scenario step, viewing a first list of one or more first job openings 31a within the job board section 30 of the first webpage 10 based on a first set of job search filters 211 of the first scenario 21a; selecting a second scenario 21b from the n distinct scenarios 21 within the job search filtering section 20 of the first webpage 10; in response to said selecting the second scenario step, viewing a second list of one or more second job openings 31b within the job board section 30 of the first webpage 10 based on a second set of job search filters 211 of the second scenario 21b, the second list of one or more second job openings 3 lb within the job board section 30 of the first webpage 10 being different from or the same as the first list of one or more first job openings 31a within the job board section 30 of the first webpage 10; selecting a job opening posting 31 within the job board section 30 of the first webpage 10; in response to said selecting a job opening posting step, viewing one or more job details 310 about the selected job opening 31 within the job board section 30, the one or more job details 310 about the selected job opening 31 comprising one or more of: a job title, a company name, a job type, a job term, a location of the job, a job description, and company information; applying for a given job opening 31 displayed within the job board section 30 on the first webpage 10; and in response to said applying step, initiating an information transfer to an employer or a recruiting company for the selected job opening 31, wherein the information transfer comprises providing, to the employer or the recruiting company, an electronic copy of at least one of: (i) a resume, (ii) contact information, or (iii) any combination thereof.
51. The method of embodiment 50, further comprising: in response to said applying step, viewing an electronic notice to the job seeker on the first webpage 10 that an employer or a recruiting company received notice of the job seeker's interest in a given job opening 31.
52. The method of embodiment 50 or 51, further comprising: in response to said applying step, viewing an electronic message to the job seeker on the first webpage 10 with feedback related to a given job opening 31, the feedback comprises notice to the job seeker that the job seeker lacks one or more items needed for the given job opening 31, notice to the job seeker that the given job opening 31 has been filled, notice to the job seeker that an employer representative or recruiting company representative wants to schedule an interview, or any combination thereof
53. The method of any one of embodiments 50 to 52, further comprising: allowing the job seeker to create and save up to n distinct scenarios 21, each distinct scenario 21n comprising one or more job search filters 211 completed by the job seeker.
54. The method of embodiment 53, wherein each distinct scenario 21n comprising from about 4 to about 12 job search filters 211 utilized by the job seeker.
55. The method of any one of embodiments 50 to 54, further comprising: allowing the job seeker to proceed to an edit scenarios view 200 of the first webpage 10, the edit scenario view 200 providing the job seeker with one or more scenario editing options 26 selected from: (1) editing an existing scenario 26a, (2) creating a new scenario 26b, and (3) deleting an existing scenario (not shown).
56. The method of any one of embodiments 50 to 55, further comprising: allowing the job seeker to input a keyword search term 27 into a keyword search field 29 within the search result section 30 of the first webpage 10 so as to display job search results 31 within the search result section 30 that (1) correspond to job search filters 211 of one of more selected scenarios 21 from the list of up to n distinct scenarios 21, and (2) contain the keyword search term 27 inputted into the keyword search field 29. See, for example, the keyword search term 27 “media” within the keyword search field 29 shown in FIG. 8.

Computer System Embodiments:

57. A computer system 200 comprising: a network interface 304/305; and a processor 201 in communication with the network interface 304/305, the processor 201 being configured to perform the method of any one of embodiments 1to 56.
58. A computer system 200 comprising: a network interface 304/305; and a processor 201 in communication with the network interface 304/305, the processor 201 being configured to: display a list of one or more search filtering scenarios 21 within a search filtering section 20 of a searching view 100 of a first webpage 10; display a first list of one or more search results 31a within a search result section 30 of the searching view 100 of the first webpage 10 based on a first set of search filters 211 of a first scenario 21a displayed in the list of one or more search filtering scenarios 21; and in response to selecting a second scenario 21b displayed in the list of one or more search filtering scenarios 21, display a second list of one or more search results 31b within the search result section 30 based on a second set of search filters 211 of the second scenario 31b.
59. The computer system 200 of embodiment 57 or 58, wherein the processor 201 is configured to: display a list of one or more search filtering scenarios 21 within a search filtering section 20 of the searching view 100 of the first webpage 10 comprises displaying up to n scenarios 21 within the search filtering section 20. As noted above, n may be any whole number. Typically, n ranges from about 2 to about 100 (or any number between 2 and 100), more typically, from about 3 to about 10.
60. The computer system 200 of any one of embodiments 57 to 59, wherein the processor 201 is configured to: display up to about twelve distinct scenarios 21 within the search filtering section 20.
61. The computer system 200 of any one of embodiments 57 to 60, wherein the processor 201 is configured to: display one or more additional search filtering options 22 within the search filtering section 20, the one or more additional search filtering options 22 comprising at least one of: (i) an all-inclusive search target option 22a, and (ii) a general description search option 22b.
62. The computer system 200 of any one of embodiments 57 to 61, wherein the processor 201 is configured to: in response to a user deselecting the first scenario 21a, remove the first list of one or more search results 31a from the search result section 30.
63. The computer system 200 of any one of embodiments 57 to 62, wherein the processor 201 is configured to: in response to creating a new user account, display one or more empty fields 210 for search filters 211 for forming a new scenario within the search result section 30. See, for example, the searching view 100 of the first webpage 10 shown in FIG. 1.
64. The computer system 200 of embodiment 63, wherein the one or more search filters 211 comprise up to x search filters 211 within the search result section 30 of the first webpage 10. As noted above, x may be any whole number. Typically, x ranges from about 2 to about 100 (or any number between 2 and 100), more typically, from about 3 to about 10.
65. The computer system 200 of embodiment 63 or 64, wherein the processor 201 is configured to: in response to the searcher inputting and saving information within fields 210 of the search filters 211, creating the first scenario 21a and displaying the first scenario 21a within the search filtering section 20 of the first webpage 10. See, for example, the view of first webpage 10 shown in FIG. 2.
66. The computer system 200 of any one of embodiments 57 to 65, wherein the processor 201 is configured to: in response to selecting an edit scenarios button 24 of the searching view 100 of the first webpage 10, display an edit scenario view 200 of the first webpage 10, the edit scenario view 200 providing the searcher with one or more scenario editing options 26 selected from: (1) editing an existing scenario 26a, (2) creating a new scenario 26b, and (3) deleting an existing scenario (not shown).
67. The computer system 200 of embodiment 66, wherein the processor 201 is configured to: in response to selecting the editing an existing scenario option 26a, display previously completed fields 210 of the search filters 211 for the existing scenario 21 (e.g., first scenario 21a) within the search result section 30 of the first webpage 10, and in response to making one or more changes in the previously completed fields 210 and saving of the one or more changes in the previously completed fields 210, display the newly edited existing scenario 21 within the search filtering section 20 of the first webpage 10.
68. The computer system 200 of embodiment 66 or 67, wherein the processor 201 is configured to: in response to selecting the creating a new scenario option 26b, display empty fields 210 of the search filters 211 for a new scenario 21 within the search result section 30 of the first webpage 10, and in response to making one or more changes in the empty fields 210 and saving of the one or more changes in the empty fields 210, display the new scenario 21 within the search filtering section 20 of the first webpage 10.
69. The computer system 200 of any one of embodiments 66 to 68, wherein the edit scenario view 200 of the first webpage 10 provides a return button 28, and in response to the searcher selecting the return button 28, returning to the searching view 100 of the first webpage 10 showing the list of one or more filtering scenarios 21 within the search filtering section 20 of a first webpage 10.
70. The computer system 200 of any one of embodiments 57 to 69, wherein the processor 201 is configured to: in response to selecting (i.e., highlighting) two or more scenarios 21 (e.g., first scenario 21a and third scenario 21c) from the list of one or more filtering scenarios 21 within the search filtering section 20, display search results 31 within the search result section 30 of the first webpage 10 based on distinct sets of search filters 211 of the two or more scenarios. As shown, for example, in FIG. 8, all search results 31a/31b/31c associated with each of first scenario 21a, second scenario 21b and third scenario 21c are shown in the search result section 30 of the first webpage 10.
71. The computer system 200 of any one of embodiments 57 to 70, wherein the processor 201 is configured to: in response to inputting a keyword search term 27 within a keyword search field 29 within the search result section 30 of the first webpage 10, display search result 31 within the search result section 30 that (1) correspond to search filters 221 of one of more selected scenarios 21 from list of one or more filtering scenarios 21, and (2) contain the keyword search term 27 inputted into the keyword search field 29. See, for example, the keyword search term “media” within the keyword search field 29 shown in FIG. 8.
72. The computer system 200 of any one of embodiments 57 to 71, wherein the processor 201 is configured to: in response to selecting (i.e., highlighting) a specific search result 31 within the search result section 30 of the first webpage 10, display one or more details 310 about the specific search result 31 within the search result section 30. See, for example, details shown in FIGS. 9A-9B.
73. The computer system 200 of embodiment 72, wherein the one or more details 310 about the specific search result 31 comprise one or more of: a job title, a company name, a job type, a job term, a location of the job, a job description, company information, vehicle information, a vehicle owner's contact information, or any combination thereof.
74. The computer system 200 of embodiment 72 or 73, wherein the processor 201 is configured to: in response to deselecting (i e , unhighlighting) the specific search result 31 within the search result section 30 of the first webpage 10, remove the one or more details 310 of the specific search result 31 from the search result section 30.
75. The computer system 200 of any one of embodiments 72 to 74, wherein the processor 201 is configured to: display a contact option 311 for the specific search result 31 within the search result section 30 of the first webpage 10. For example, see exemplary contact option 311 shown in the form of an “Apply” button 311 in FIG. 9A.
76. The computer system 200 of embodiment 75, wherein the processor 201 is configured to: in response to selecting the contact option 311, initiate an information transfer between the searcher and a third party associated with the specific search result 31.
77. The computer system 200 of embodiment 76, wherein the information transfer comprises providing, to the third party, contact information of the searcher.
78. The computer system 200 of any one of embodiments 75 to 77, wherein the processor 201 is configured to: in response to the searcher selecting the contact option 311, initiate an electronic notice to the searcher that the third party received notice of the searcher's interest in the specific search result 31.
79. A computer system 200 comprising: a network interface 304/305; and a processor 201 in communication with the network interface 304/305, the processor 201 being configured to: allow a searcher to perform each of the following tasks on a single webpage comprising a first webpage 10: viewing a complete list of one or more search results 31 within a search result section 30 of the first webpage 10; viewing a search filtering section 20 of the first webpage 10, the search filtering section 20 comprising a list of up to n distinct scenarios 21 with each scenario 21n comprising a set of search filters 211 that filter one or more search results 31 from a complete list of possible search targets; selecting a first scenario 21a from the n distinct scenarios 21 within the search filtering section 20 of the first webpage 10; in response to said selecting the first scenario step, viewing a first list of one or more first search results 31a within the search result section 30 of the first webpage 10 based on a first set of search filters 211 of the first scenario 21a; selecting a second scenario 21b from the n distinct scenarios 21 within the search filtering section 20 of the first webpage 10; in response to said selecting the second scenario step, viewing a second list of one or more second search results 31b within the search result section 30 of the first webpage 10 based on a second set of search filters 211 of the second scenario 21b, the second list of one or more second search results 31b within the search result section 30 of the first webpage 10 being different from or the same as the first list of one or more first search results 31a within the search result section 30 of the first webpage 10; selecting a search result 31 within the search result section 30 of the first webpage 10; in response to said selecting a search result step, viewing one or more details 310 about the selected search result 31 within the search result section 30; selecting a given search result contact option 311 displayed within the search result section 30 on the first webpage 10; and in response to said selecting a given search result contact option step, initiating an information transfer to a third party for the selected search result, wherein the information transfer comprises providing, to the third party, an electronic copy of contact information of the searcher.
80. The computer system 200 of embodiment 79, wherein the one or more details 310 about the selected search result 31 comprises one or more of: a job title, a company name, a job type, a job term, a location of the job, a job description, company information, vehicle information, vehicle owner information, etc.
81. The computer system 200 of embodiment 79 or 80, wherein the processor 201 is configured to: allow the searcher to create and save up to n distinct scenarios 21, each distinct scenario 21n comprising one or more search filters 211 completed by the searcher.
82. The computer system 200 of embodiment 81, wherein each distinct scenario 21n comprising from about 4 to about 12 search filters 211 utilized by the searcher.
83. The computer system 200 of embodiment 81 or 82, wherein the one or more search filters 211 comprise Location, Compensation, Industry, Job Type, Job Term, Daily Job Email Update, vehicle type, maximum vehicle cost, vehicle year, (or any other search term), or any combination thereof.
84. The computer system 200 of any one of embodiments 79 to 83, wherein the processor 201 is configured to: allow the searcher to proceed to an edit scenarios view 200 of the first webpage 10, the edit scenario view 200 providing the searcher with one or more scenario editing options 26 selected from: (1) editing an existing scenario 26a, (2) creating a new scenario 26b, and (3) deleting an existing scenario (not shown).
85. The computer system 200 of any one of embodiments 79 to 84, wherein the processor 201 is configured to: allow the searcher to input a keyword search term 27 into a keyword search field 29 within the search result section 30 of the first webpage 10 so as to display search results 31 within the search result section 30 that (1) correspond to search filters 211 of one of more selected scenarios 21 from the list of up to n distinct scenarios 21, and (2) contain the keyword search term 27 inputted into the keyword search field 29. See, for example, the keyword search term 27 “media” within the keyword search field 29 shown in FIG. 8.
86. A computer system 200 comprising: a network interface 304/305; and a processor 201 in communication with the network interface 304/305, the processor 201 being configured to: display a list of one or more job search filtering scenarios 21 within a search filtering section 20 of a searching view 100 of a first webpage 10; display a first list of one or more job openings 31a within a job board search result section 30 of the searching view 100 of the first webpage based on a first set of job search filters 221 of a first scenario 21a selected from the list of one or more job search filtering scenarios 21; and in response to selecting a second scenario 21b within the search filtering section 20 of the first webpage 10, display a second list of one or more job openings 31b within the job board search result section 30 of the first webpage 10 based on a second set of job search filters 221 of the second scenario 21b.
87. The computer system 200 of embodiment 86, wherein the processor 201 is configured to: display up to n job search filtering scenarios 21 within the search filtering section 20.
88. The computer system 200 of embodiment 86 or 87, wherein the processor 201 is configured to: display up to about twelve distinct job search filtering scenarios 21 within the search filtering section 20.
89. The computer system 200 of any one of embodiments 86 to 88, wherein the processor 201 is configured to: display one or more additional job search filtering options 22 within the search filtering section 20, the one or more additional job search filtering options 22 comprising at least one of: (i) an all-inclusive job search target option 22a, and (ii) a general description job search option 22b.
90. The computer system 200 of any one of embodiments 86 to 89, wherein the processor 201 is configured to: in response to deselecting the first job search filtering scenario 21a, remove the first list of one or more job search results 31a from the search result section 30.
91. The computer system 200 of any one of embodiments 86 to 90, wherein the processor 201 is configured to: in response to creating a new user account, display one or more empty fields 210 for job search filters 211 for forming a new scenario within the search result section 30. See, for example, the searching view 100 of the first webpage 10 shown in FIG. 1.
92. The computer system 200 of embodiment 91, wherein the one or more job search filters 211 comprise up to x job search filters 211 within the search result section 30 of the first webpage 10.
93. The computer system 200 of embodiment 91 or 92, wherein the processor 201 is configured to: in response to the searcher inputting and saving information within fields 210 of the job search filters 211, create the first job search filtering scenario 21a and display the first job search filtering scenario 21a within the search filtering section 20 of the first webpage 10. See again, for example, the view of first webpage 10 shown in FIG. 2.
94. The computer system 200 of any one of embodiments 86 to 93, wherein the processor 201 is configured to: in response to selecting an edit scenarios button 24 of the searching view 100 of the first webpage 10, display an edit scenario view 200 of the first webpage 10, the edit scenario view 200 providing the searcher with one or more scenario editing options 26 selected from: (1) editing an existing job search filtering scenario 26a, (2) creating a new job search filtering scenario 26b, and (3) deleting an existing job search filtering scenario (not shown).
95. The computer system 200 of embodiment 94, wherein the processor 201 is configured to: in response to selecting the editing an existing scenario option 26a, display previously completed fields 210 of the job search filters 211 for the existing job search filtering scenario 21 (e.g., first job search filtering scenario 21a) within the search result section 30 of the first webpage 10, and in response to making one or more changes in the previously completed fields 210 and saving of the one or more changes in the previously completed fields 210, display the newly edited existing job search filtering scenario 21 within the search filtering section 20 of the first webpage 10.
96. The computer system 200 of embodiment 94 or 95, wherein the processor 201 is configured to: in response to selecting the creating a new job search filtering scenario option 26b, display empty fields 210 of the job search filters 211 for a new job search filtering scenario 21 within the search result section 30 of the first webpage 10, and in response to making one or more changes in the empty fields 210 and saving of the one or more changes in the empty fields 210, display the new job search filtering scenario 21 within the search filtering section 20 of the first webpage 10.
97. The computer system 200 of any one of embodiments 94 to 96, wherein the edit scenario view 200 of the first webpage 10 provides a return button 28, and in response to the searcher selecting the return button 28, returning to the searching view 100 of the first webpage 10 showing the list of one or more job search filtering scenarios 21 within the search filtering section 20 of a first webpage 10. See again, for example, return button 28 shown in FIG. 4 and designated “Back to Job Board” in this specific exemplary embodiment.
98. The computer system 200 of any one of embodiments 86 to 97, wherein the processor 201 is configured to: in response to selecting (i.e., highlighting) two or more job search filtering scenarios 21 (e.g., first job search filtering scenario 21a and third job search filtering scenario 21c) from the list of one or more job search filtering scenarios 21 within the search filtering section 20, display search results 31 within the search result section 30 of the first webpage 10 based on distinct sets of job search filters 211 of the two or more job search filtering scenarios. As shown, for example, in FIG. 8, all search results 31a/31b/31c associated with each of first job search filtering scenario 21a, second job search filtering scenario 21b and third job search filtering scenario 21c, respectively, are shown in the search result section 30 of the first webpage 10.
99. The computer system 200 of any one of embodiments 86 to 98, wherein the processor 201 is configured to: in response to inputting a keyword search term 27 within a keyword search field 29 within the search result section 30 of the first webpage 10, display job search result 31 within the search result section 30 that (1) correspond to job search filters 221 of one of more selected job search filtering scenarios 21 from list of one or more job search filtering 21, and (2) contain the keyword search term 27 inputted into the keyword search field 29.
100. The computer system 200 of any one of embodiments 86 to 99, wherein the processor 201 is configured to: in response to selecting (i.e., highlighting) a specific job search result 31 within the search result section 30 of the first webpage 10, display one or more job details 310 about the specific job search result 31 within the search result section 30. See again, for example, job details shown in FIGS. 9A-9B.
101. The computer system 200 of embodiment 100, wherein the one or more job details 310 about the specific search result 31 comprise one or more of: a job title, a company name, a job type, a job term, a location of the job, a job description, company information, or any combination thereof.
102. The computer system 200 of embodiment 100 or 101, wherein the processor 201 is configured to: in response to deselecting (i e , unhighlighting) the specific job search result 31 within the search result section 30 of the first webpage 10, remove the one or more job details 310 of the specific job search result 31 from the search result section 30.
103. The computer system 200 of any one of embodiments 100 to 102, wherein the processor 201 is configured to: display a contact option 311 for the specific job search result 31 within the search result section 30 of the first webpage 10. For example, see again exemplary contact option 311 shown in the form of an “Apply” button 311 in FIG. 9A.
104. The computer system 200 of embodiment 103, wherein the processor 201 is configured to: in response to selecting the contact option 311, initiate an information transfer between the searcher and a third party associated with the specific job search result 31.
105. The computer system 200 of embodiment 104, wherein the information transfer comprises providing, to the third party, one or more of: contact information of the searcher, a resume, or both.
106. The computer system 200 of any one of embodiments 103 to 105, wherein the processor 201 is configured to: in response to the searcher selecting the contact option 311, initiate an electronic notice to the searcher that the third party received notice of the searcher's interest in the specific job search result 31.
107. A computer system 200 comprising: a network interface 304/305; and a processor 201 in communication with the network interface 304/305, the processor 201 being configured to:

allow a job seeker to perform each of the following tasks on a single webpage comprising a first webpage 10: viewing a complete list of one or more job openings 31 within a job board section 30 of the first webpage 10; viewing a job search filtering section 20 of the first webpage 10, the job search filtering section 20 comprising up to n distinct scenarios 21 with each scenario 21n comprising a set of job search filters 211 that filter one or more jobs 31 from the complete list of one or more job openings 31 based on the set of job search filters 211; selecting a first scenario 21a from the n distinct scenarios 21 within the job search filtering section 20 of the first webpage 10; in response to said selecting the first scenario step, viewing a first list of one or more first job openings 31a within the job board section 30 of the first webpage 10 based on a first set of job search filters 211 of the first scenario 21a; selecting a second scenario 21b from the n distinct scenarios 21 within the job search filtering section 20 of the first webpage 10; in response to said selecting the second scenario step, viewing a second list of one or more second job openings 31b within the job board section 30 of the first webpage 10 based on a second set of job search filters 211 of the second scenario 21b, the second list of one or more second job openings 31b within the job board section 30 of the first webpage 10 being different from or the same as the first list of one or more first job openings 31a within the job board section 30 of the first webpage 10; selecting a job opening posting 31 within the job board section 30 of the first webpage 10; in response to said selecting a job opening posting step, viewing one or more job details 310 about the selected job opening 31 within the job board section 30, the one or more job details 310 about the selected job opening 31 comprising one or more of: a job title, a company name, a job type, a job term, a location of the job, a job description, and company information; applying for a given job opening 31 displayed within the job board section 30 on the first webpage 10; and in response to said applying step, initiating an information transfer to an employer or a recruiting company for the selected job opening 31, wherein the information transfer comprises providing, to the employer or the recruiting company, an electronic copy of at least one of: (i) a resume, (ii) contact information, or (iii) any combination thereof.

108. The computer system 200 of embodiment 107, wherein the processor 201 is configured to: in response to said applying step, allow a job seeker to view an electronic notice on the first webpage 10 that an employer or a recruiting company received notice of the job seeker's interest in a given job opening 31.
109. The computer system 200 of embodiment 107 or 108, wherein the processor 201 is configured to: in response to said applying step, allow a job seeker to view an electronic message on the first webpage 10 with feedback related to a given job opening 31, the feedback comprises notice to the job seeker that the job seeker lacks one or more items needed for the given job opening 31, notice to the job seeker that the given job opening 31 has been filled, notice to the job seeker that an employer representative or recruiting company representative wants to schedule an interview, or any combination thereof
110. The computer system 200 of any one of embodiments 107 to 109, wherein the processor 201 is configured to: allow the job seeker to create and save up to n distinct scenarios 21, each distinct scenario 21n comprising one or more job search filters 211 completed by the job seeker.
111. The computer system 200 embodiment 110, wherein each distinct scenario 21n comprising from about 4 to about 12 job search filters 211 utilized by the job seeker.
112. The computer system 200 of any one of embodiments 107 to 111, wherein the processor 201 is configured to: allow the job seeker to proceed to an edit scenarios view 200 of the first webpage 10, the edit scenario view 200 providing the job seeker with one or more scenario editing options 26 selected from: (1) editing an existing scenario 26a, (2) creating a new scenario 26b, and (3) deleting an existing scenario (not shown).
113. The computer system 200 of any one of embodiments 107 to 112, wherein the processor 201 is configured to: allow the job seeker to input a keyword search term 27 into a keyword search field 29 within the search result section 30 of the first webpage 10 so as to display job search results 31 within the search result section 30 that (1) correspond to job search filters 211 of one of more selected scenarios 21 from the list of up to n distinct scenarios 21, and (2) contain the keyword search term 27 inputted into the keyword search field 29.
114. The computing system 200 of any one of embodiments 57 to 113, the processor being further configured to: provide a log-in page for a user; in response to input from the user, determine whether the user is a job seeker, a system administrator, an employer, or a recruiting company; and direct the user to a specific webpage depending on whether the user is a job seeker, a system administrator, an employer, or a recruiting company.
115. The computing system 200 of any one of embodiments 47 to 71, further comprising a storage device 304/305 that stores information comprising job seeker data, employer data, recruiting company data, scenario data, scenario data, vehicle data, vehicle owner data, (or any other data), or any combination thereof, the processor 201 being in communication with the storage device 304/305.

It should be noted that in any of the above-described embodiments, methods and computing systems of the present invention may further comprise various interactions between a user (e.g., a searcher) and a party associated with one or more items within the searchable database. For example, in the case of a job posting database, a job seeker that has shown interest in a particular search result (i.e., job) may receive one or more correspondence from a potential employer regarding the particular job. The herein-described methods and systems may automatically send out specifically formulated messages to a job seeker when, for example, the job has been filled, the job posting has been removed from the database, and/or any time period (e.g., two weeks) after any such event occurs.

It should be understood that although the above-described methods and/or computing systems are described as “comprising” one or more components or steps, the above-described methods and/or computing systems may “comprise,” “consists of,” or “consist essentially of” the above-described components, features or steps of the methods and/or computing systems. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a method and/or computing system that “comprises” a list of elements (e.g., components, features, or steps) is not necessarily limited to only those elements (or components or steps), but may include other elements (or components or steps) not expressly listed or inherent to the method and/or computing system.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a method and/or computing system that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Further, it should be understood that the herein-described methods and/or computing systems may comprise, consist essentially of, or consist of any of the herein-described components, features and steps, as shown in the figures with or without any feature(s) not shown in the figures. In other words, in some embodiments, the method or computing system of the present invention does not have any additional features other than those shown in the figures, and such additional features, not shown in the figures, are specifically excluded from the method and/or computing system. In other embodiments, the method or computing system of the present invention does have one or more additional features that are not shown in the figures.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of providing search information to a searcher via a web-based system, said method comprising:
displaying a list of one or more search filtering scenarios within a search filtering section of a searching view of a first webpage;
displaying a first list of one or more search results within a search result section of the searching view of the first webpage based on a first set of search filters of a first scenario displayed in the list of one or more search filtering scenarios; and
in response to selecting a second scenario displayed in the list of one or more search filtering scenarios, displaying a second list of one or more search results within the search result section based on a second set of search filters of the second scenario.

2. The method of claim 1, wherein said displaying a list of one or more search filtering scenarios within a search filtering section of the searching view of the first webpage comprises displaying up to n scenarios within the search filtering section.

3. The method of claim 1, further comprising:
displaying one or more additional search filtering options within the search filtering section, the one or more additional search filtering options comprising at least one of: (i) an all-inclusive search target option, and (ii) a general description search option.

4. The method of claim 1, further comprising:
in response to deselecting the first scenario, removing the first list of one or more search results from the search result section.

5. The method of claim 1, further comprising:
in response to creating a new user account, displaying one or more empty fields for search filters for forming a new scenario within the search result section.

6. The method of claim 5, wherein the one or more search filters comprise up to x search filters within the search result section of the first webpage.

7. The method of claim 5, further comprising:
in response to the searcher inputting and saving information within fields of the search filters, creating the first scenario and displaying the first scenario within the search filtering section of the first webpage.

8. The method of claim 1, further comprising:
in response to selecting an edit scenarios button of the searching view of the first webpage, displaying an edit scenario view of the first webpage, the edit scenario view providing the searcher with one or more scenario editing options selected from: (1) editing an existing scenario, (2) creating a new scenario, and (3) deleting an existing scenario.

9. The method of claim 8, further comprising:
in response to selecting the editing an existing scenario option, displaying previously completed fields of the search filters for the existing scenario within the search result section of the first webpage, and in response to making one or more changes in the previously completed fields and saving of the one or more changes in the previously completed fields, displaying the newly edited existing scenario within the search filtering section of the first webpage.

10. The method of claim 8, further comprising:
in response to selecting the creating a new scenario option, displaying empty fields of the search filters for a new scenario within the search result section of the first webpage, and in response to making one or more changes in the empty fields and saving of the one or more changes in the empty fields, displaying the new scenario within the search filtering section of the first webpage.

11. The method of claim 8, wherein the edit scenario view of the first webpage provides a return button, and in response to the searcher selecting the return button, returning to the searching view of the first webpage showing the list of one or more filtering scenarios within the search filtering section of a first webpage.

12. The method of claim 1, further comprising:
in response to selecting two or more scenarios from the list of one or more filtering scenarios within the search filtering section, displaying search results within the search result section of the first webpage based on distinct sets of search filters of the two or more scenarios.

13. The method of claim 1, further comprising:
in response to inputting a keyword search term within a keyword search field within the search result section of the first webpage, displaying search result within the search result section that (1) correspond to search filters of one of more selected scenarios from list of one or more filtering scenarios, and (2) contain the keyword search term inputted into the keyword search field.

14. The method of claim 1, further comprising:
in response to selecting a specific search result within the search result section of the first webpage, displaying one or more details about the specific search result within the search result section.

15. The method of claim 14, wherein the one or more details about the specific search result comprise one or more of: a job title, a company name, a job type, a job term, a location of the job, a job description, company information, vehicle information, a vehicle owner's contact information, or any combination thereof.

16. The method of claim 14, further comprising:
in response to deselecting the specific search result within the search result section of the first webpage, removing the one or more details of the specific search result from the search result section.

17. The method of claim 14, further comprising:
displaying a contact option for the specific search result within the search result section of the first webpage, and in response to selecting the contact option, initiating an information transfer between the searcher and a third party associated with the specific search result.

18. A method of enabling a search via a web-based system, said method comprising:
allowing a searcher to perform each of the following tasks on a single webpage comprising a first webpage:
viewing a complete list of one or more search results within a search result section of the first webpage;
viewing a search filtering section of the first webpage, the search filtering section comprising a list of up to n distinct scenarios with each scenario comprising a set of search filters that filter one or more search results from a complete list of possible search targets;
selecting a first scenario from the n distinct scenarios within the search filtering section of the first webpage;
in response to said selecting the first scenario step, viewing a first list of one or more first search results within the search result section of the first webpage based on a first set of search filters of the first scenario;
selecting a second scenario from the n distinct scenarios within the search filtering section of the first webpage;
in response to said selecting the second scenario step, viewing a second list of one or more second search results within the search result section of the first webpage based on a second set of search filters of the second scenario, the second list of one or more second search results within the search result section of the first webpage being different from or the same as the first list of one or more first search results within the search result section of the first webpage;
selecting a search result within the search result section of the first webpage;
in response to said selecting a search result step, viewing one or more details about the selected search result within the search result section;
selecting a given search result contact option displayed within the search result section on the first webpage; and
in response to said selecting a given search result contact option step, initiating an information transfer to a third party for the selected search result, wherein the information transfer comprises providing, to the third party, an electronic copy of contact information of the searcher.

19. The method of claim 18, wherein the one or more details about the selected search result comprises one or more of: a job title, a company name, a job type, a job term, a location of the job, a job description, company information, vehicle information, vehicle owner information, etc.

20. The method of claim 18, further comprising:
allowing the searcher to create and save up to n distinct scenarios, each distinct scenario comprising one or more search filters completed by the searcher, wherein the one or more search filters comprise one or more of: Location, Compensation, Industry, Job Type, Job Term, Daily Job Email Update, vehicle type, maximum vehicle cost, vehicle year, or any combination thereof;
allowing the searcher to proceed to an edit scenarios view of the first webpage, the edit scenario view providing the searcher with one or more scenario editing options selected from: (1) editing an existing scenario, (2) creating a new scenario, and (3) deleting an existing scenario; and
allowing the searcher to input a keyword search term into a keyword search field within the search result section of the first webpage so as to display search results within the search result section that (1) correspond to search filters of one of more selected scenarios from the list of up to n distinct scenarios, and (2) contain the keyword search term inputted into the keyword search field.
